(19) United States
(12) Patent Application Publication
(10) Pub. No.: US 2024/0119302 A1
(43) Pub. Date: Apr. 11, 2024

(54) EVALUATING REPRESENTATIONS WITH READ-OUT MODEL SWITCHING

(71) Applicant: DeepMind Technologies Limited, London (GB)

(72) Inventors: Yazhe Li, London (GB); Jorg Bornschein, London (GB); Marcus Hutter, London (GB)

(21) Appl. No.: 18/475,972

(22) Filed: Sep. 27, 2023

Related U.S. Application Data
(60) Provisional application No. 63/411,005, filed on Sep. 28, 2022.

(51) Int. Cl. G06N 3/092

(52) U.S. Cl. CPC G06N 3/092

(57) ABSTRACT

A method of automatically selecting a neural network from a plurality of computer-implemented candidate neural networks, each candidate neural network comprising at least an encoder neural network trained to encode an input value as a latent representation. The method comprises: obtaining a sequence of data items, each of the data items comprising an input value and a target value; and determining a respective score for each of the candidate neural networks, comprising evaluating the encoder neural network of the candidate neural network using a plurality of read-out heads. Each read-out head comprises parameters for predicting a target value from a latent representation of an input value of a data item encoded using the encoder neural network of the candidate neural network. The method further comprises selecting the neural network from the plurality of candidate neural networks using the respective scores.

### CROSS-REFERENCE TO RELATED APPLICATION

This application claims priority under 35 U.S.C. 119 to Provisional Application No. 63/411,005, filed Sep. 28, 2022, which is incorporated by reference.

### BACKGROUND

This specification relates to neural network systems and methods for evaluating neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a method and corresponding system for rigorously evaluating neural networks in terms of the quality of representations of input data that the neural networks can generate. Such evaluation allows better performing neural networks to be selected automatically (i.e. without supervision) for different applications. The selected neural network may then be used to provide representations of input data for use in a downstream task, such that the representations are higher-quality or better suited to the task than representations generated by other neural networks for the same input data. The downstream task may then be performed with greater accuracy and/or using fewer computational or memory resources as a result of the representations generated by the selected neural network. As an example, the selected neural network may encode image data, in which case, the selected neural network may be used in e.g. an image classifier, an image processing system or an image generation system.

Thus in one aspect of the present disclosure there is described a method, and a corresponding system, for automatically selecting a neural network from a plurality of computer-implemented candidate neural networks. Each of the candidate neural networks comprises at least an encoder neural network trained to encode an input value as a latent representation (i.e. an encoding or embedding), e.g. by training (in particular using unsupervised learning) on a set of training data items. The encoder neural network of the neural network may be used to generate a latent (i.e. intermediate or hidden) representation of any suitable input data item. For example, the representation may be of (pixels of) an input image, in which case the encoder neural network may for example be referred to as an image or vision encoder. For example, the downstream task may involve performing an image classification operation on an image representation. As another example, an image segmentation operation may be performed on the image representation. Other image processing tasks may alternatively or additionally be performed. The representation thus generated may be used by many different downstream tasks depending on the type of data that is encoded.

In some implementations, the encoder neural network generates a latent representation of an input data item that is a text data item, e.g. a text query. The latent representation of a text data item may be provided as an input to a model (e.g. a language model or other generative model) that has been trained to process the latent representation to generate, in response, an output data item comprising one or more of: text, image data, audio data, and video data.

The method may comprise obtaining a sequence of data items, each of the data items comprising an input value and a target value. In some described examples the data items comprise images, but in general any type of data item may be used.

The method may further comprise determining a respective score for each of the candidate neural networks. The determining may comprise evaluating the encoder neural network of the candidate neural network using a plurality of read-out heads. Each read-out head may comprise parameters for predicting a target value from a latent representation of an input value of a data item encoded using the encoder neural network of the candidate neural network. The prediction task performed by the read-out heads may be referred to as a prediction or downstream task. The read-out head may, for example, comprise a neural network, such as a feedforward neural network, e.g. a multilayer perceptron, or a single (e.g. linear) layer. In some examples, the read-out heads comprise respective neural networks that have differing numbers of layers e.g. one read-out head may comprise a single layer, whilst other read-out heads may comprise neural networks having 2- or 3-layers (or a higher number of layers).

The method may further comprise selecting the neural network from the plurality of candidate neural networks using the respective scores (e.g. based on comparing or ranking the scores).

The respective score for each of the candidate neural networks may be based on a respective information score for each of a plurality of mappings, each mapping being a choice for each of the data items of a corresponding one of the read-out heads. The information score for a given mapping may depend on a cumulative performance, over the sequence of data items, of the corresponding read-out heads in predicting the target values of the data items from a latent representation produced by the encoder neural network of the input values of the data items.

In implementations, one or more of the mappings may include at least two of the read-out heads. In some examples, some of the mappings may include the same read-out head for each of the data items. Typically, for a given data item, each read-out head may be included in more than one of the mappings, i.e. a mapping is not precluded from including a particular read-out head for a given data item if that read-out head is also included for the given data item in another of the mappings.

In implementations, determining the information score for a given mapping may comprise: using the encoder neural network of the candidate neural network to encode the input value of the data item as a latent representation; and, for each of the corresponding read-out heads, determining a loss value using the target value of the data item and a predicted target value of the data item obtained by processing the latent representation using the read-out head. The loss value may be a cross-entropy loss, for example. In some examples, the information score for a given mapping may comprise a product of the loss values determined by the corresponding read-out heads. The loss values may in some cases be used to compare the performance of the different read-out heads.

In some implementations, the method may further comprise determining the respective information scores for the mappings by iterating over the data items in the sequence and updating the parameters of the read-out heads by training or retraining each of the read-out heads after one or more data items have been processed by the read-out head. Optionally, each read-out head may be trained or retrained on a training dataset comprising one or more of the data items that the read-out head has processed (e.g. all the data items the read-out head has processed so far, or just the most-recent data item). Data items later in the sequence may be excluded from the training dataset, for example. Optionally, the training or retraining may be performed by gradient descent, e.g. stochastic gradient descent or mini-batch gradient descent.

In some examples, the encoder neural network may be trained (“fine-tuned”) on the data items.

In implementations, the mappings may be selected according to a hidden Markov model (HMM). For example, each information score may be weighted by transition probabilities reflecting the probability of the mapping under the hidden Markov model. In some cases, the plurality of mappings comprises all possible mappings, i.e. mappings that together span every combination of the read-out heads.

In implementations, the information score may be or may comprise a minimum description length (MDL) score, preferably a prequential minimum description length score. The MDL score (or more generally, the information score) may be indicative of a complexity of the encoder neural network and/or the read-out heads specified by each mapping. By including the complexity in the evaluation metric, the need to limit the readout head complexity may be avoided, such that the scores obtained for different mappings can be compared freely. For example, if the latent representations generated by one of the encoder neural networks are nonlinear and therefore require a higher capacity read-out head to perform a task, the information score may reflect this by having a larger complexity term.

In some implementations, each data item comprises a still or moving image or an audio signal. For some examples, each candidate neural network comprises a trained variational autoencoder (VAE) neural network.

In some implementations, the selected neural network may be used in an image, video or audio classification and/or recognition system. In such cases, the encoder neural network may generate a latent representation of image and/or audio data which is used to classify the data and/or recognize one or more features in the data (e.g. particular objects or configurations of objects).

In implementations, the latent representation of each candidate neural network may comprise a vector with the same number of latent values. Each candidate neural network has one or more of i) a different set of hyperparameter values, ii) a different set of weight initialization values, and (iii) a different number of layers. The method may be used to select an encoder neural network that generates the highest quality representations for a given memory footprint of the encoder neural network and/or the latent representation.

In some examples, the method may further comprise using at least the encoder neural network of the selected computer-implemented neural network in i) a classification neural network system; ii) a reinforcement learning neural network system; or iii) a data storage and/or transmission system.

Optionally, the method may further comprise using the loss values determined by the read-out heads to select one of the read-out heads for use with the selected neural network.

The method and system may be implemented as one or more computer programs on one or more computers in one or more locations. Some implementations of the method are adapted to parallel operation, for example on a distributed computing system. For example, the read-out heads may be trained in parallel with one another using a suitable computing system, e.g. a distributed computing system, a graphics-processing unit (GPU), or a tensor-processing unit (TPU). In some examples, the read-out heads may additionally or alternatively determine the respective loss values for a given data item in parallel with one another. In general, each read-out head may be operated independently (i.e. in parallel) from the other read-out heads. An online implementation of the method may be used in which there is an online stage in which the loss values are determined using successive data items and an offline stage which calculates the information scores using the loss values. Such an approach may reduce memory requirements by avoiding the need to store large numbers of data items at the same time.

In another aspect, the present disclosure provides a computer-implemented encoder neural network selected from a plurality of candidate encoder neural networks on the basis of respective scores determined for each of the candidate encoder neural networks, each of the encoder neural networks being for encoding an input value as a latent representation. The score for each encoder neural network may be determined by: obtaining a sequence of data items, each of the data items comprising an input value and a target value; and evaluating the encoder neural network using a plurality of read-out heads each read-out head comprising parameters for predicting a target value from a latent representation of an input value of a data item encoded using the encoder neural network. The score for the encoder neural network may be based on a respective information score for each of a plurality of mappings. Each mapping may be a choice for each of the data items of a corresponding one of the read-out heads. The information score for a given mapping may depend on a cumulative performance, over the sequence of data items, of the corresponding read-out heads in predicting the target values of the data items from a latent representation produced by the encoder neural network of the input values of the data items.

The encoder neural network may be a part of a neural network for performing any of the tasks described above for the earlier aspects, e.g. a downstream task performed by the read-out heads.

In a further aspect, the present disclosure provides an encoded representation of input data for storage or transmission. The encoded representation may be produced by an encoder neural network selected from a plurality of candidate encoder neural networks on the basis of respective scores determined for each of the candidate encoder neural networks, each of the encoder neural networks being for encoding an input value as an encoded representation. The score for each encoder neural network may be determined by: obtaining a sequence of data items, each of the data items comprising an input value and a target value; and evaluating the encoder neural network using a plurality of read-out heads. Each read-out head may comprise parameters for predicting a target value from an encoded representation of an input value of a data item encoded using the encoder neural network. The score for the encoder neural network may be based on a respective information score for each of a plurality of mappings. Each mapping may be a choice for each of the data items of a corresponding one of the read-out heads. The information score for a given mapping may depend on a cumulative performance, over the sequence of data items, of the corresponding read-out heads in predicting the target values of the data items from an encoded representation produced by the encoder neural network of the input values of the data items.

The encoded representation (i.e. latent representation or embedding) of the input data may be stored on a physical medium, such as computer memory, e.g. read only memory (ROM) or random access memory (RAM). The encoded representation may also be decoded to recover the input data or a version of the input data, e.g. using a decoder neural network. Transmission of the encoded representation may be over a data network, e.g. the internet, in some examples. A receiver of the encoded representation may be configured to decode received encoded data.

In another aspect, the present disclosure provides a method of encoding input data, the method comprising using an encoder neural network selected from a plurality of candidate encoder neural networks on the basis of respective scores determined for each of the candidate encoder neural networks. Each of the encoder neural networks may be for encoding an input value as a latent representation. The score for each encoder neural network may be obtained by: obtaining a sequence of data items, each of the data items comprising an input value and a target value; and evaluating the encoder neural network using a plurality of read-out heads. Each read-out head may comprise parameters for predicting a target value from a latent representation of an input value of a data item encoded using the encoder neural network. The score for the encoder neural network may be based on a respective information score for each of a plurality of mappings. Each mapping may be a choice for each of the data items of a corresponding one of the read-out heads. The information score for a given mapping may depend on a cumulative performance, over the sequence of data items, of the corresponding read-out heads in predicting the target values of the data items from a latent representation produced by the encoder neural network of the input values of the data items.

In implementations, a method of decoding the encoded input data may comprise using a decoder neural network to decode the encoded input data, the decoder neural network having been trained to decode data encoded using the selected encoder network.

The method of encoding input data may be performed as part of any of the tasks described above for the earlier aspects, e.g. to allow a downstream task, such as that performed by the read-out heads to be performed (or any other task that uses the encoded input data).

The details of one or more embodiments of the subject matter described in this specification are set forth in the accompanying drawings and the description below. Other features, aspects, and advantages of the subject matter will become apparent from the description, the drawings, and the claims.

The subject matter described in this specification can be implemented in particular embodiments so as to realize one or more of the following advantages.

As described, the present disclosure provides a way of rigorously and objectively evaluating encoder neural networks in terms of the representations (i.e. encodings) that the neural networks can generate for use in a downstream task. The information scores used to evaluate the neural networks depend on the cumulative performance, over a sequence of data items, of different read-out heads in predicting the target values of the data items from an encoding produced by the encoder neural network of the input values of the data items. Thus, the scores obtained for different candidate neural networks provide a measure (metric) of how effectively the plurality of read-out heads can use the encodings to perform the downstream task, (which as noted above may be image, sound or video classification, for example). The scores may therefore be used to select an encoder neural network that is particularly suitable for use in a neural network system directed towards the downstream task.

The methods and systems described herein may allow an encoder neural network to be selected to provide encodings for a downstream task that provides the best performance for a given set of memory or processing requirements. For example, the performance of encoder neural networks may be accurately compared to determine a minimum size for the encoder neural network (e.g. a minimum number of layers and/or connections) that provides acceptable performance when used in the downstream task. Thus, the selected encoder neural network may have reduced memory or computational requirements. In some cases, this may allow the selected encoder neural network to be used in environments that are constrained in terms of memory or processing power, e.g. mobile devices.

The use of multiple read-out heads in combination may overcome disadvantages in existing approaches that use only a single read-out head to evaluate an encoder neural network. In particular, the present disclosure may allow the most suitable read-out head to be selected for the task being performed to evaluate the performance of the encoder neural network. Thus, biases arising from the choice of read-out head used to evaluate the encoder neural network may be minimized or eliminated.

The present disclosure may also allow read-out heads that perform favorably with the encoder neural network to be identified. In other words, the loss scores and/or information scores used to determine the score for a candidate neural network may be analyzed to identify which of the read-out heads performs best for the downstream task. A neural network that is the same as or similar to the best-performing read-out head may then be used in combination with the selected neural network system to perform the downstream task in a subsequent application.

The loss values and/or information scores may also allow the performance of the read-out heads in using the encodings from the encoder neural network to be monitored as a function of the number of data items that have been processed (i.e. as a function of the size of the training dataset used to train the read-out heads). Thus, read-out heads that can be trained efficiently to perform the downstream task using the encodings of input data provided by the encoder neural network can be identified. Therefore, a neural network that is the same as or similar to the most efficient read-out head may be selected for use in combination with the encoder neural network in applications. The computational resources needed to train such neural network systems may therefore be reduced, e.g. because of reduced size of training dataset may be needed.

The progress in training the read-out heads, as indicated by the loss values, may be used to identify when fine tuning (i.e. further training) of the encoder neural network is worthwhile, i.e. whether or not the performance of the encoder neural network and the read-outs heads together is limited by the training of the read-out heads or of the encoder neural network.

### BRIEF DESCRIPTION OF THE DRAWINGS

FIG. 1 is a schematic illustration of an example system for selecting a neural network from a plurality of computer-implemented candidate neural networks.

FIG. 2 is a graph showing next step cross entropy for successive data items of an input data sequence evaluated for different read-out heads.

FIG. 3 is a flow diagram showing a procedure used by the system of FIG. 1 for selecting the neural network.

FIG. 4 is a flow diagram showing a procedure for encoding input data using used an encoder neural network selected using the method of FIG. 3.

### DETAILED DESCRIPTION

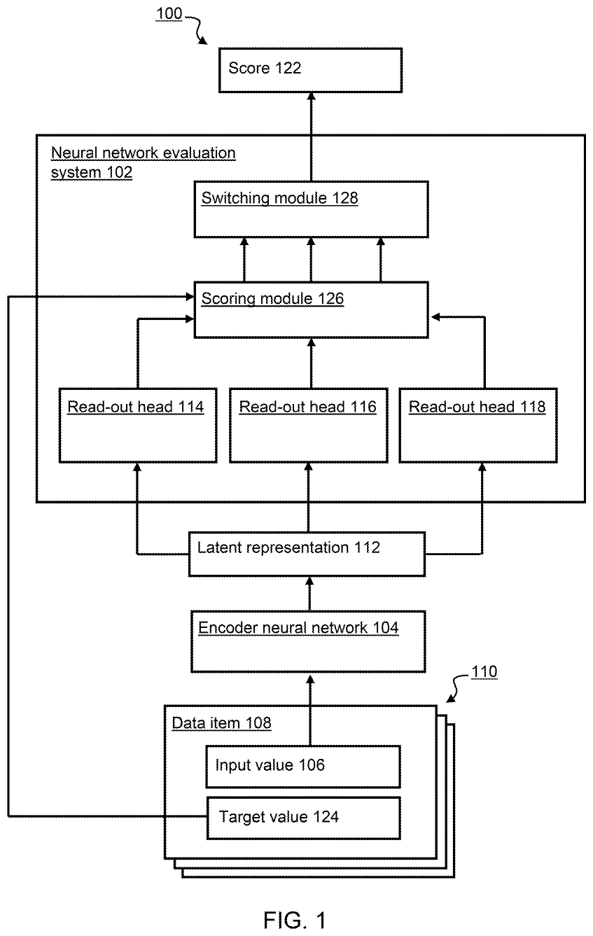

FIG. 1 illustrates an example of a system 100 for selecting a neural network from a plurality of computer-implemented candidate neural networks. The system 100 comprises a neural network evaluation system 102 for evaluating an encoder neural network 104 of a plurality of (candidate) encoder neural networks. Each encoder neural network 104 is configured to process an input value xₜ 106 of a data item (xₜ, yₜ) 108 of a sequence of data items {(xₜ, yₜ)}₁^{N} 110 to determine a latent (encoded) representation 112 of the input value xₜ 106.

The neural network evaluation system 102 comprises a plurality of read-out heads 114, 116, 118, a scoring module 120, and a switching module 128, which are used together for determining a score 122 for evaluating the quality of the latent representations 112 generated by the encoder neural network 104 for use in a prediction task performed by each of the read-out heads.

Each of the read-out heads 114, 116, 118 is configured to process a latent representation 112 to determine a predicted value that the scoring module 118 compares with the target value yₜ 120 corresponding to the input value xₜ 106 of the data item (xₜ, yₜ) 120 from which the latent representation 112 was generated. The scoring module 118 may compare each of the predicted values with the corresponding target value yₜ 124 by determining a loss value using a loss function, such as a cross entropy loss function (although other loss functions may be used). The scoring module 126 is configured to provide the loss value determined for each of the read-out heads for each data item 108, to the switching module 128.

The switching module 128 combines the loss values for the data items 108 in the sequence 110 to generate a plurality of information scores from which the score 122 for the encoder neural network 104 is determined. Each information score is generated according to a respective mapping, which is a choice for each of the data items 108 in the sequence 110 of a corresponding one of the read-out heads 114, 116, 118. The information score for a given mapping depends on a cumulative performance, over the sequence of data items 110, of the corresponding read-out heads 114, 116, 118 in predicting the target values 124 of the data items 108 from the latent representation 112 produced by the encoder neural network 104 for each of the data items 108.

Each mapping may be represented as sequence of identifiers {ξₜ}₁^{N} which is in 1:1 correspondence with the sequence of data items {(xₜ, yₜ)}₁^{N} 110, with each identifier ξₜ identifying one of the read-out heads 114, 116, 118 for the corresponding data item (xₜ, yₜ) 108 in the sequence of data items 110. The mappings may be determined using a hidden Markov model (HMM) comprising respective transition probabilities p_{ξ}_{ₜ}(ξₜ|ξₜ₋₁) for switching from any one of the read-out heads ξₜ₋₁ to a another of the read-out heads ξₜ for each of the data items (xₜ, yₜ) 108 in the sequence 110. The transition probabilities p_{ξ}_{ₜ}(ξₜ|ξₜ₋₁) may include a probability that no transition takes place, i.e. a probability that the read-out head ξₜ selected for the current data item (xₜ, yₜ) remains the same as the read-out head ξₜ₋₁ for the preceding data item (xₜ₋₁, yₜ₋₁). Each information score may be calculated by using the transition probabilities to determine a weighted product of the loss values. The plurality of mappings may comprise all possible mappings in some cases.

The switching module 128 determines the score 122 for the encoder neural network 104 by combining (e.g. summing or averaging) the information scores for each of the mappings. The score 122 for the encoder neural network may therefore be marginalized over the choice of read-out head 114, 116, 118. The score 122 may be compared with corresponding scores 122 obtained for other encoder neural networks 104 without the comparison being influenced significantly by the choice of a particular read-out head to evaluate the quality of the latent representations 112 generated by the encoder neural networks. Compared to existing approaches for evaluating representations that use a linear layer (or “probe”), the present disclosure may therefore avoid or reduce problems caused by weak performance of probing when used to evaluate the latent representations generated by some encoder neural networks.

The read-out heads 114, 116, 118 may be trained on the current data item 108 and the data items 108 preceding the current data item in the sequence of data items {(xₜ, yₜ)}₁^{N} 110. That is, the parameters of each of the read-out heads 114, 116, 118 may be adjusted to minimize or otherwise reduce a loss function (which may be the same as or different from the loss function used by the scoring module 118) for each of the data items 108. The training may be performed by stochastic gradient descent or mini-batch gradient descent, for example. The training may be online training, such that the parameters of each of the read-out heads 114, 116, 118 are updated as the data items 108 are processed, i.e. as the latent representations 112 corresponding to each of the data items 108 are processed by each read-out head. Alternatively, each of the read-out heads 114, 116, 118 may be trained on the sequence of data items {(xₜ, yₜ)}₁^{N} 110 and each of the loss values that was determined during the training stored for later processing by the switching module 128 to determine the score 122.

After computing the information score, a posterior over the read-out heads can be inspected for each of the data items to see which of the read-out heads 114, 116, 118 is preferred for the encoder neural network 104, thereby providing valuable insight into the characteristics of the latent representation 112, which may allow latent representations that are more data efficient to be identified (for example).

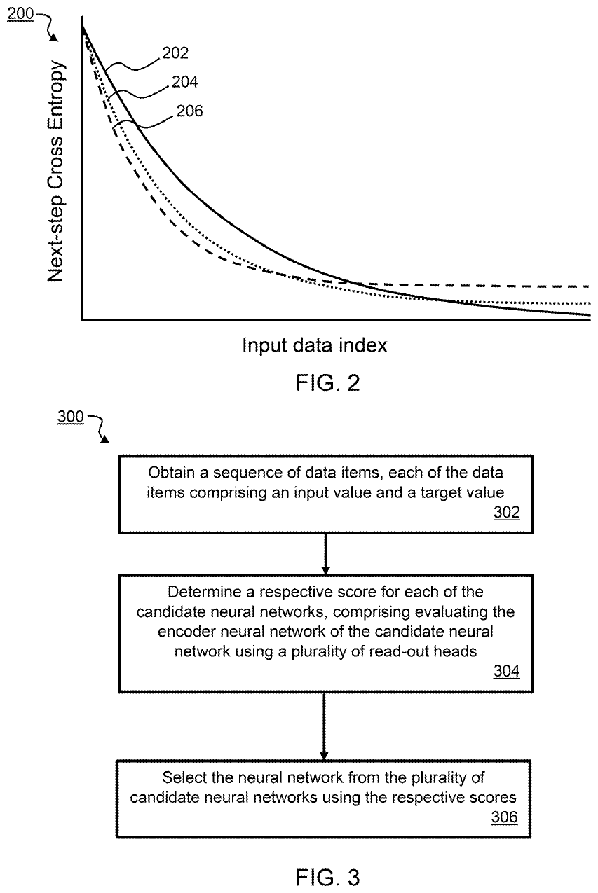

FIG. 2 shows loss curves 202, 204, 206 illustrating how the loss values determined for each of the read-out heads 114, 116, 118 may vary as a they are trained on the sequence of data items 110 i.e. as a function of an index identifying the position of each data item 108 in the sequence of data items 110. Typically, the loss values decrease as the number of training examples increases (i.e. as the number of data items processed increases). The loss curves 202, 204, 206 may intersect one another as shown in FIG. 2, i.e. the relative ordering of the curves may vary as the number of data items 110 processed increases. For example, the loss curve 206 for a first of the read-out heads 118 may have loss values that are less than the loss values of the loss curve 202 of a second of the read-out heads 114 for an initial portion of the sequence of data items 110. Nevertheless, the second read-out head 114 may ultimately achieve lower loss values than the first read-out head 118 once the read-out heads have been trained on the entire sequence of data items 110. The relative performances of the read-out models and the shapes of the training curves 202, 204, 206, are also influenced by which encoder neural network 104 is used to generate the latent representations 112 of the input values 106 of the data items 108. To account for these differences, the switching module 128 determines the score 122 for each encoder neural network 104 by combining information scores for a plurality of mappings corresponding to different choices of read-out head 114, 116, 118 as the data items 108 in the sequence of data items 110 are processed. For example, the score 122 may be determined by combining information scores from all possible mappings of the read-out heads over the data items 108 in the sequence 110. In some implementations, the information score for each mapping may be determined from the area under a loss curve generated for the corresponding mapping using the loss values of corresponding read-out head 114, 116, 118 specified in the mapping for each of the data items 108.

In some implementations, a Minimum Description Length (MDL) is used as the information score. MDL performs a similar role as held-out validation does for Empirical Risk Minimization (ERM), but has the advantage of being able to deal with single sequence and non-stationary data. MDL is related to Bayesian model selection and includes a form of Occam's Razor where the evaluation metric takes into account the model complexity. The complexity term may be explicitly represented as the codelength of the model (i.e. read-out head) in the case of a 2-part code, as a KL-term (i.e. Kullback-Leibler divergence term) when using a variational code, or implicitly when using prequential or Bayesian codes. The present disclosure defines a model selection problem for representation evaluation under the MDL principle: the objective is to compare the encoder neural network ϕ(.) that minimizes the codelength L(D|ϕ)=−log p(D|ϕ), where D={(xₜ, yₜ)}ₜ₌₁^{T} denotes the sequence of input values xₜ and the associated prediction target values yₜ and t is a timestep (index) used to iterate over the input data items. In order to achieve a short description length, it is beneficial if the latent representation generated by the encoder neural network allows the read-out head (model) to be capable of fast learning, i.e. given a good latent representation, a few examples are enough for the read-out head to achieve good performance.

The information score may be determined by prequential MDL, which decomposes the codelength into the cumulative prediction loss L(D|ϕ)=−Σₜ₌₁^{T} log p(yₜ|ϕ_{≤t}, y_{<t}), where ϕₜ=ϕ(xₜ) is the encoded feature of input xₜ. In order to perform the prediction task from the latent representation, existing approaches fix the read-out head to be a linear layer or a multilayer perceptron, MLP. In the present disclosure, instead of picking a single read-out head, a hybrid of continuous and discrete-valued (k, θₖ) space of the read-out heads is used, where k∈[1, . . . , K] is the read-out head class (i.e. particular read-out head) and θₖ denotes the continuous-valued parameters corresponding to the read-out head class k. Each read-out head can be seen as an expert forecasting system that learns to predict the data independently in an online fashion. At each datapoint xₜ, the prediction of ŷₜ is a combination of the experts' predictions. The final MDL score (or information score, in the more general case) is the cumulative predictive performance of the board of experts for the sequence of data items.

In one embodiment, K read-out heads are provided and the read-out head to use may be described using random variables (ξₜ) denoting each of the 1 to K read-out heads at each timestep t, i.e. ξₜ∈[1, . . . , K], ∀t∈[1, . . . , T]. A hidden Markov model (HMM) may be used to define the joint distribution of the data items (denoted by D) and the random variables (ξₜ) for a particular encoder neural network (ϕ) may be denoted:

$$p ( D , {ξ}_{0 : T} \vert ϕ ) = p ( {ξ}_{0} ) {\prod }_{t = 1}^{T} {p}_{{ξ}_{t}} ( {y}_{t} \vert {ϕ}_{\leq t} , {y}_{< t} ) p ( {ξ}_{t} \vert {ξ}_{t - 1} )$$

where p(ξ₀) is an initial distribution and pₖ (.) is the prediction of the kth read-out head. At each timestep t, the previously observed data items are used to estimate \hat{θ}ₖ(ϕ_{<t}, y_{<t}) for the parameters of the read-out heads. Therefore, the kth read-out head prediction pₖ(yₜ|ϕ_{<t}, y_{<t}) is the plugin distribution, pₖ(yₜ|ϕₜ, \hat{θ}ₖ(ϕ_{<t}, y_{<t})). The final read-out head switching codelength function may be in the form of:

$${L}_{Switch} ( D \vert ϕ ) = - log ( p ( D \vert ϕ ) = - log {\sum }_{{ξ}_{0 : T}} p ( {ξ}_{0} ) {\prod }_{t = 1}^{T} p ( {y}_{t} \vert {ϕ}_{t} , {\hat{θ}}_{{ξ}_{t}} ( {ϕ}_{< t} , {y}_{< t} ) ) p ( {ξ}_{t} \vert {ξ}_{t - 1} )$$

The read-out head switching defined in this equation represents a family of codes that combines prequential and Bayesian MDL. From the perspective of a hidden Markov model, p(ξₜ|ξₜ₋₁) is the transition matrix; in the present context, it is equivalent to a switching strategy between the read-out heads. Every switching strategy corresponds to a specific code in the family. For example, if p(ξₜ|ξₜ₋₁)=1, i.e. we stick to one read-out head for the whole data sequence, and the equation simplifies to a Bayesian mixture code:

$${L}_{Switch} ( D \vert ϕ ) = - log {\sum }_{k} p ( k ) {\prod }_{t = 1}^{T} p ( {y}_{t} \vert {ϕ}_{t} , {\hat{θ}}_{k} ( {ϕ}_{< t} , {y}_{< t} ) ) p ( {ξ}_{t} \vert {ξ}_{t - 1} )$$

In one implementation, a fixed share (FS) strategy may be used as the switching strategy. The prior defined in the fixed share strategy can be interpreted as follows: at timestep t, with a probability 1−αt, the read-out head is the same as the previous timestep; with at probability, it switches to another read-out head according to the probability w(k), e.g. a uniform distribution w(k)=1/K. At the switching point, one or more different read-out heads other than the current one may be chosen, e.g. a selection may be made from among all available read-out heads. The switching strategy may be expressed mathematically as:

$$P ( {ξ}_{t} \vert {ξ}_{t - 1} ) = \{ \begin{matrix}1 - \frac{K - 1}{K} {α}_{t} if {ξ}_{t} = {ξ}_{t - 1} \\ \frac{1}{K} {α}_{t} if {ξ}_{t} \neq {ξ}_{t - 1}\end{matrix}$$

where

$${α}_{t} = \frac{m - 1}{t} ∈ [ 0 , 1 ]$$

is decreasing over the timestep t and m is a hyperparameter.

It will be appreciated, however, that switching strategies other than the FS strategy described above may be used alternatively or additionally, e.g. elementwise mixture, fixed share with constant switching rate, switch distribution and run-length model, etc.

In some implementations, a fully online implementation for computing MDL may be used. Conceptually, the implementation may involve an algorithm comprising: (i) after seeing a new data item: obtaining a final prediction using by the weighted predictions from each of the read-out heads according to the current belief of mixtures; (ii) revealing the target data item y t , the cross-entropy loss of the final prediction is calculated and added to the cumulative loss; (iii) the belief of the mixture is then updated; and (iv) finally, the new data item is added to the training data and the parameters of the heads are updated, e.g. via gradient descent. Efficient implementations of the algorithm can be obtained by using a HMM forward pass algorithm. A fully online implementation can be decomposed into an online stage of parameter estimation which logs the per-step cross-entropy loss of the heads, and an offline stage which combines and updates the mixtures. Such a 2-stage implementation may be more flexible in some cases.

In one implementation, an algorithm for online implementation of MDL with read-out head switching may be used. The algorithm may be expressed in pseudocode as:

Algorithm 1 MDL with Read-out Head Switching (Fully Online)

Require: data D = (xₜ, yₜ )ₜ₌₁^{T}, K read-out heads; distribution of initial switching
probabilities p(ξ₁) and switching strategy p(ξₜ|ξₜ₋₁); subroutine that updates the
parameters given a dataset UpdateParameters

| | |
|---|---|
| 1: | Initialize: model parameters θ₁,..., θ_{K} ; s = log p(ξ₁) |
| 2: | for t = 1 to T do |
| 3: | Compute log p(ξₜ, y^{t-1}\|x^{t-1}): s ← logΣ_{ξ}_{_{t−1}} exp(log p(ξₜ\|ξₜ₋₁) + s) |
| 4: | Compute next-step loss of K read-out heads: |
| | Lₜ^{k} := − log pₖ(yₜ\|xₜ) = − log pₖ(yₜ\|xₜ; θₖ) |
| 5: | Combine K heads to update log p(ξₜ, y^{t}\|x^{t}): s ← Lₜ^{k} + s |
| 6: | for k = 1 to K do |
| 7: | Update parameters: θₖ ← UpdateParameters(θₖ, D_{≤t}) |
| 8: | end for |
| 9: | end for |
| 10: | Compute total codelength L_{Switch} ← −logΣ_{ξ}_{ₜ} exp(s) |
| 11: | return L_{Switch} |

In another implementation, a two-stage algorithm for read-out head switching may be expressed in pseudocode as:

Algorithm 2 MDL with Readout Model Switching (2-Stage)

Stage 1:
Require: data D = (xₜ, yₜ )ₜ₌₁^{T}, K read-out heads; subroutine that updates the parameters
given a dataset UpdateParameters

| | |
|---|---|
| 1: | Initialize: model parameters θ₁,..., θ_{K}; an empty list L to store loss per step and per model |
| 2: | for t = 1 to T do |
| 3: | Compute next-step loss of K read-out heads: |
| | Lₜ^{k} := − log pₖ(yₜ\|xₜ) = − log pₖ(yₜ\|xₜ; θₖ) |
| 4: | Store Lₜ¹, ... , Lₜ^{K} , to L |
| 5: | for k = 1 to K do |
| 6: | Update parameters: θₖ ← UpdateParameters(θₖ, D_{≤t}) |
| 7: | end for |
| 8: | end for |
| 9: | return L |

Stage 2:
Require: Cross entropy results from stage 1 L; distribution of initial switching probabilities
p(ξ₁) and switching strategy p(ξₜ|ξₜ₋₁);

| | |
|---|---|
| 1: | Initialize: s = log p(ξ₁); an empty list Q to store posterior p(ξₜ\|D_{<t}) |
| 2: | for t = 1 to T do |
| 3: | Compute log p(ξₜ, y^{t-1}\|x^{t-1}): s ← logΣ_{ξ}_{_{t−1}} exp(log p(ξₜ\|ξₜ₋₁) + s) |
| 4: | Compute posterior p(ξₜ\|D_{<t}) and store in Q: |
| | log p(ξₜ\|D_{<t}) = log p(ξₜ, y^{t-1}\|x^{t-1}) − logΣ_{ξ}_{ₜ₁} p(ξₜ, y^{t-1}\|x^{t-1}) |
| 5: | Get Lₜ¹, ... , Lₜ^{K} from L and combine K read-out heads to update |
| | log p(ξₜ, y^{t}\|x^{t}): s ← Lₜ^{k} + s |
| 6: | end for |
| 7: | Compute total codelength L_{Switch} ← −logΣ_{ξ}_{ₜ} exp(s) |
| 8: | return L_{Switch} |

FIG. 3 is a flow diagram of an exemplary process 300 that may be performed by a system of one or more computers located in one or more locations. For example, the process 300 may be performed by a system comprising a neural network evaluation system, such as the neural network evaluation system 102 shown in FIG. 1. The system obtains a sequence of data items, each of the data items comprising an input value and a target value (step 302). The system then determines a respective score for each of the candidate neural networks, comprising evaluating the encoder neural network of the candidate neural network using a plurality of read-out heads (step 304). The system then selects the neural network from the plurality of candidate neural networks using the respective scores (step 306).

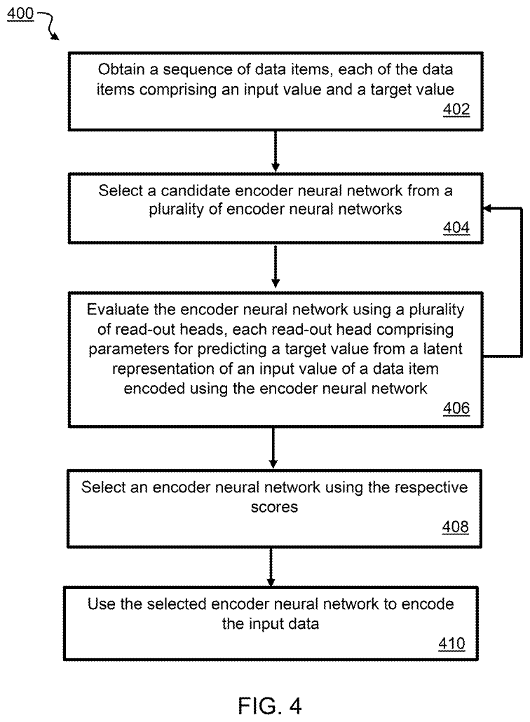

FIG. 4 is a flow diagram of an exemplary process 400 for encoding input data that may be performed by a system of one or more computers located in one or more locations. The process 400 may be performed by a system comprising a neural network evaluation system, such as the neural network evaluation system 102 shown in FIG. 1. The system obtains a sequence of data items, each of the data items comprising an input value and a target value (step 402). The system may then select a candidate encoder neural network from a plurality of candidate neural networks (step 404). The system evaluates the encoder neural network using a plurality of read-out heads, each read-out head comprising parameters for predicting a target value from a latent representation of an input value of a data item encoded using the encoder neural network (step 406). The score for the encoder neural network is based on a respective information score for each of a plurality of mappings, each mapping being a choice for each of the data items of a corresponding one of the read-out heads. The information score for a given mapping depending on a cumulative performance, over the sequence of data items, of the corresponding read-out heads in predicting the target values of the data items from a latent representation produced by the encoder neural network of the input values of the data items. Steps 404 and 406 are then repeated until each of the candidate neural networks has been assigned a respective score.

The system then uses the scores to select an encoder neural network (step 408). The system may then uses the selected encoder neural network to encode the input data (step 410).

In general, the encoder neural networks described herein may be configured to process data items that are images, videos, audio data, text data, or other types of data item. The read-out heads may be configured to perform any type of task (downstream task) that involves predicting a target value from a latent representation of an input value of a data item encoded using the encoder neural network.

In the case of image data the image data may comprise color or monochrome pixel value data. Such image data may be captured from an image sensor such as a camera or LIDAR sensor. In the case of audio data the audio data may comprise a representation of a digitized audio waveform e.g. a speech waveform. Such a representation may comprise samples representing digitized amplitude values of the waveform or, e.g., a time-frequency domain representation of the waveform such as a STFT (Short-Term Fourier Transform) or MFCC (Mel-Frequency Cepstral Coefficient) representation.

In the case of an image data item, which as used here includes a video data item, the tasks may include any sort of image processing or vision task such as an image classification or scene recognition task, an image segmentation task e.g. a semantic segmentation task, an object localization or detection task, a depth estimation task. When performing such a task the input value may comprise or be derived from pixels of the image. For an image classification or scene recognition task the output may comprise a classification output providing a score for each of a plurality of image or scene categories e.g. representing an estimated likelihood that the input data item or an object or element of the input data item, or an action within a video data item, belongs to a category.

For an image segmentation task the output may comprise, for each pixel, an assigned segmentation category or a probability that the pixel belongs to a segmentation category, e.g. to an object or action represented in the image or video. For an object localization or detection task the output may comprise data defining coordinates of a bounding box or region for one or more objects represented in the image. For a depth estimation task the output may comprise, for each pixel, an estimated depth value such that the output pixels define a (3D) depth map for the image. Such tasks may also contribute to higher level tasks e.g. object tracking across video frames; or gesture recognition i.e. recognition of gestures that are performed by entities depicted in a video.

Another example image processing task may include an image keypoint detection task in which the output comprises the coordinates of one or more image keypoints such as landmarks of an object represented in the image, e.g. a human pose estimation task in which the keypoints define the positions of body joints. A further example is an image similarity determination task, in which the output may comprise a value representing a similarity between two images, e.g. as part of an image search task.

In some examples, each data item represents an audio waveform, or the waveform of any signal, for example, a signal from a sensor, e.g. a sensor sensing a physical characteristic of an object or of the real world. Where the data item represents a waveform e.g. an audio waveform, the downstream task may comprise, for example: an identification or classification task such as a speech or sound recognition task, a phone or speaker classification task, or an audio tagging task, in which case the output may be a category score or tag for a data item or for a segment of the data item; or a similarity determination task e.g. an audio copy detection or search task, in which case the output may be a similarity score.

In some implementations, the data items may be text data items and the read-out heads may perform a task comprising an identification or classification task, or a similarity determination task, e.g. to generate a category score, a similarity score, or a tag as described above; or a machine translation task. A data item may also represent an observation e.g. an observation of advertisement impressions or a click-through counts or rate, e.g. in combination with other data such as text data.

In some cases, the selected encoder neural network may be included in a neural network system for controlling an agent interacting with an environment. The environment may be a real-world environment, and the agent may be an agent, e.g. a mechanical agent such as a robot or vehicle, which operates in the real-world. More specifically the selected encoder neural network may process observations characterizing states of the real-world environment, e.g. from an image sensor or other sensors of or associated with the mechanical agent, to generate representations that are used by an action selection system that processes the representations to generate action control data for controlling the agent operating in the real-world to perform a task such as manipulating or moving an object or navigating in the environment. Alternatively, the environment may be a simulated environment. The agent may be trained using reinforcement learning, for example. The relatively higher quality of the representations provided by the selected encoder neural network may improve the actions selected for or by the agent and/or allow for faster learning, for example.

Also described herein is an exemplary system for evaluating an encoder neural network using a sequence of data items. Each data item has an input value and a target value (e.g. a label or “ground truth” value associated with the input value). The encoder neural network is configured to encode an input value of a data item as a latent representation (or “encoding”). The system comprises a plurality of read-out heads (in general any number of read-out heads may be used). The read-out heads are each configured to determine a respective loss value (e.g. a cross entropy loss value) using the target value of the data item and a predicted target value of the data item obtained by processing the latent representation using the read-out head. The loss values are indicative of the performance of the corresponding read-out heads in predicting the target values. When each of the data items in the sequence have been processed, an information score for the encoder neural network is calculated based on a weighted sum over the loss values calculated by the read-out heads. After each data item is processed by the read-out heads and the information scores updated, the read-out heads are each trained on training data that includes the additional data item, i.e. a respective set of parameters used by each of the read-out heads to predict the target values for data items are adjusted. The training may, for example, be by gradient descent, e.g. stochastic gradient descent. The training data may comprise only data items no later in the sequence than the current data item. Mini-batch gradient descent may be used in such cases, for example. In some implementations, the training may be online mini-batch gradient descent training on the previously processed data items.

Also described herein a method of automatically selecting a neural network from a plurality of computer-implemented candidate neural networks. Each candidate neural network comprises at least an encoder neural network trained to encode an input value as a latent representation. For example, each candidate neural network may comprise a trained variational autoencoder neural network. In some implementations, the latent representation of each candidate neural network may comprise a vector with the same number of latent values, and wherein each candidate neural network has one or more of i) a different set of hyperparameter values, and ii) a different set of weight initialization values, and (iii) a different number of layers.

In a first step, the method comprises obtaining a sequence of data items, each of the data items comprising an input value and a target value. The method may then comprise determining a respective score for each of the candidate neural networks by evaluating (“probing”) the encoder neural network of the candidate neural network using each of a plurality of read-out heads and switching between the read-out heads during the probing. The method may also comprise comparing the scores of the candidate neural networks to select one of the candidate neural networks. Comparing the scores may, for example, comprise finding the candidate neural network with the minimum score, or ranking the candidate neural networks according to their scores (in which case a highest ranking one or more of the candidate neural networks may be selected).

The method may, for example, be performed using the system described above. In that case, a plurality of the read-out heads may be used to probe (evaluate) the encoder neural network of each of the candidate neural networks to determine an information score for each of the encoder neural networks. The information scores are then compared to select the best-performing encoder neural network for the downstream task, as determined by the read-out heads.

The neural network selected from the candidate neural networks (or at least the encoder neural network of the selected neural network) may be used in a variety of applications. In some implementations, the selected (encoder) neural network is used in a classification neural network system, e.g. as described above; a reinforcement learning neural network system, e.g. as described above; a data storage and/or transmission system; or an image processing neural network system e.g. configured to process pixels of an image to perform an image processing task. In some implementations, the selected (encoder) neural network is included in a neural network system that is configured to perform the same task as the read-out heads used to evaluate the candidate neural networks.

When used in a data storage and/or transmission system the encoder neural network may be used to encode data for storage in a memory or transmission over a communications link of limited bandwidth. The representations (i.e. encodings) generated by the encoder neural network can provide a compressed representation that requires less memory storage of communications bandwidth for storage or compression of a data item, e.g. an image, audio, or text data item as previously described. The stored or transmitted data item can be recovered using a decoder neural network to process the compressed representation to recover a version of the original data item. Any type of decoder neural network may be used; it may be trained to decode a data item using supervised learning based on data items and their representations (encodings).

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method of automatically selecting a neural network from a plurality of computer-implemented candidate neural networks, each candidate neural network comprising at least an encoder neural network trained to encode an input value as a latent representation, the method comprising:
obtaining a sequence of data items, each of the data items comprising an input value and a target value; and
determining a respective score for each of the candidate neural networks, comprising evaluating the encoder neural network of the candidate neural network using a plurality of read-out heads, each read-out head comprising parameters for predicting a target value from a latent representation of an input value of a data item encoded using the encoder neural network of the candidate neural network; and
selecting the neural network from the plurality of candidate neural networks using the respective scores;
wherein the respective score for each of the candidate neural networks is based on a respective information score for each of a plurality of mappings, each mapping being a choice for each of the data items of a corresponding one of the read-out heads,
the information score for a given mapping depending on a cumulative performance, over the sequence of data items, of the corresponding read-out heads in predicting the target values of the data items from a latent representation produced by the encoder neural network of the input values of the data items.

2. A method according to claim 1, wherein determining the information score for a given mapping comprises:
using the encoder neural network of the candidate neural network to encode the input value of the data item as a latent representation; and
for each of the corresponding read-out heads, determining a respective loss value using the target value of the data item and a predicted target value of the data item obtained by processing the latent representation using the read-out head.

3. A method according to claim 2, wherein the loss value is a cross-entropy loss value.

4. A method according to claim 2, further comprising using the loss values to select one of the read-out heads for use with the selected neural network.

5. A method according to claim 1, further comprising determining the respective information scores for the mappings by iterating over the data items in the sequence and updating the parameters of the read-out heads by training or retraining each of the read-out heads after one or more data items have been processed by the read-out head.

6. A method according to claim 5, wherein each read-out head is trained or retrained on a training dataset comprising one or more of the data items that the read-out head has processed.

7. A method according to claim 6, wherein each read-out head is trained on the training dataset using gradient descent.

8. A method according to claim 1, wherein the mappings are selected according to a hidden Markov model.

9. A method according to claim 8, wherein each information score is weighted by transition probabilities reflecting the probability of the mapping under the hidden Markov model.

10. A method according to claim 1, wherein the plurality of mappings comprises all possible mappings.

11. A method according to claim 1, wherein the information score is or comprises a minimum description length score.

12. A method according to claim 11, further comprising using the selected neural network in an image, video or audio classification and/or recognition system.

13. A method according to claim 1, wherein each candidate neural network comprises a trained variational autoencoder neural network.

14. A method according to claim 1, wherein the latent representation of each candidate neural network comprises a vector with the same number of latent values, and wherein each candidate neural network has one or more of (i) a different set of hyperparameter values, and (ii) a different set of weight initialization values, and (iii) a different number of layers.

15. A method as claimed in claim 1 further comprising using at least the encoder neural network of the selected neural network in i) a classification neural network system; ii) a reinforcement learning neural network system; or iii) a data storage and/or transmission system.

16. A system comprising one or more computers and one or more storage devices storing instructions that when executed by the one or more computers cause the one or more computers to perform operations for automatically selecting a neural network from a plurality of computer-implemented candidate neural networks, each candidate neural network comprising at least an encoder neural network trained to encode an input value as a latent representation, the operations comprising:
obtaining a sequence of data items, each of the data items comprising an input value and a target value; and
determining a respective score for each of the candidate neural networks, comprising evaluating the encoder neural network of the candidate neural network using a plurality of read-out heads, each read-out head comprising parameters for predicting a target value from a latent representation of an input value of a data item encoded using the encoder neural network of the candidate neural network; and
selecting the neural network from the plurality of candidate neural networks using the respective scores;
wherein the respective score for each of the candidate neural networks is based on a respective information score for each of a plurality of mappings, each mapping being a choice for each of the data items of a corresponding one of the read-out heads,
the information score for a given mapping depending on a cumulative performance, over the sequence of data items, of the corresponding read-out heads in predicting the target values of the data items from a latent representation produced by the encoder neural network of the input values of the data items.

17. One or more non-transitory computer storage media storing instructions that when executed by one or more computers cause the one or more computers to perform operations for automatically selecting a neural network from a plurality of computer-implemented candidate neural networks, each candidate neural network comprising at least an encoder neural network trained to encode an input value as a latent representation, the operations comprising:
obtaining a sequence of data items, each of the data items comprising an input value and a target value; and
determining a respective score for each of the candidate neural networks, comprising evaluating the encoder neural network of the candidate neural network using a plurality of read-out heads, each read-out head comprising parameters for predicting a target value from a latent representation of an input value of a data item encoded using the encoder neural network of the candidate neural network; and
selecting the neural network from the plurality of candidate neural networks using the respective scores;
wherein the respective score for each of the candidate neural networks is based on a respective information score for each of a plurality of mappings, each mapping being a choice for each of the data items of a corresponding one of the read-out heads,
the information score for a given mapping depending on a cumulative performance, over the sequence of data items, of the corresponding read-out heads in predicting the target values of the data items from a latent representation produced by the encoder neural network of the input values of the data items.

18. The non-transitory computer storage media of claim 17, wherein determining the information score for a given mapping comprises:
using the encoder neural network of the candidate neural network to encode the input value of the data item as a latent representation; and
for each of the corresponding read-out heads, determining a respective loss value using the target value of the data item and a predicted target value of the data item obtained by processing the latent representation using the read-out head.

19. The non-transitory computer storage media of claim 18, wherein the loss value is a cross-entropy loss value.

20. The non-transitory computer storage media of claim 18, wherein the operations further comprise using the loss values to select one of the read-out heads for use with the selected neural network.
